(19) United States
(12) Patent Application Publication
(10) Pub. No.: US 2025/0314303 A1
(43) Pub. Date: Oct. 9, 2025

(54) PRESSURE BALANCED SELF-REGULATING MECHANICAL PACKING SEALING ASSEMBLY

(71) Applicant: A.W. CHESTERTON COMPANY, Groveland, MA (US)

(72) Inventors: Henri Vincent AZIBERT, Windham, NH (US); Joseph K. KALESHIAN, Burlington, MA (US)

(21) Appl. No.: 19/173,426

(22) Filed: Apr. 8, 2025

Related U.S. Application Data
(60) Provisional application No. 63/631,891, filed on Apr. 9, 2024.

(51) Int. Cl. F16J 15/34

(52) U.S. Cl. CPC F16J 15/3448

(57) ABSTRACT

A mechanical packing sealing assembly includes an axially movable pressure adjustment element having a main body that is sized and configured for seating within the recess formed in the stationary equipment. The main body can include a radially outwardly extending first flange element formed at a first end that is sized and configured for engaging with a radial surface of stationary equipment of a fluid regulating device and a radially inwardly extending second flange element formed at an opposed second end and forming a piston area for being exposed to a pressure of a process fluid in the stationary equipment. The second flange element can selectively apply an axial force to the packing assembly when coupled to the main body, and the pressure adjustment element is movable axially as a function of the pressure of the process fluid applied to the piston area.

### RELATED APPLICATION

The present application claims priority to U.S. provisional patent application Ser. No. 63/631,891, filed on Apr. 9, 2024, and entitled Pressure Balanced Self-Regulating Mechanical Packing Sealing Assembly, the contents of which are herein incorporated by reference.

### BACKGROUND OF THE INVENTION

The present invention relates to a mechanical packing sealing arrangement suitable for use with a fluid regulating device.

There exists in the art many different types of fluid regulating devices, including for example, valves, regulators, pumps, differential pressure transducers, and the like. Conventional fluid regulating devices, such as valves and pumps, are used in many different types of commercial applications to help regulate the flow of a fluid through a fluid conveyance system. Conventional valves, for example, come in many different shapes and sizes, and can include for example block or gate valves, control valves and the like. When used in commercial applications, the valves or pumps typically employ a mechanical packing assembly mounted in stationary equipment that helps reduce fluid loss and the amount of unwanted gaseous emissions that leak or are accidentally emitted from the valve or pump around a moving shaft.

The packing material typically includes a plurality of separate packing elements or components that are axially stacked together in a groove formed in the stationary equipment housing (e.g., stuffing box) of the fluid regulating device. The packing assembly is mounted about and contacts a movable shaft so as to form a fluid seal therewith. The length of each of the packing elements is typically calculated and then cut from a roll of packing material that comes in rope form, and the number of packing elements that are needed to be mounted within the equipment also needs to be determined. The individually cut packing elements are then mounted and stacked within the equipment one at a time, with careful attention being paid to the orientation of the end of each ring of packing material. An axially movable gland follower or compression gland can be employed to selectively compress the packing assembly. As the packing assembly is compressed, the packing elements expand radially to create a suitable fluid seal between the shaft and the stationary equipment housing. The seal formed by the packing assembly minimizes fluid leakage and helps maintain a pressure boundary between the process fluid housed within the stationary equipment and the external atmosphere.

An example of a conventional fluid regulating device that mounts a conventional packing assembly is shown for example in FIGS. 6-8. The illustrated fluid regulating device 200 can include a stuffing box or stationary equipment housing 202 that has a groove 204 formed along an inner surface that is sized and configured for mounting a packing assembly 210. The stuffing box 202 can be mounted about a movable shaft 206. The packing assembly 210 can include a series of packing elements 212 that are mounted and stacked within the groove 204, as is known in the art. According to one conventional embodiment, the groove 204 can be typically sized to accommodate anywhere between three and seven packing elements 212, depending upon the type and size of the fluid regulating device. In the example embodiment, five packing elements 212 are mounted within the groove 204. The device 200 can also include a compression gland element or adjustment mechanism 220 that is coupled to the stuffing box 202 by a series of fasteners 224. The gland element 220 can apply a compression or compressive force to the packing assembly 210 by compressing the packing elements 212 both axially and radially so as to ensure sealing contact between the packing assembly 210 and the shaft 206. The forces applied by the gland element 220 can be manually adjusted.

A drawback of the conventional mounting techniques for the packing elements in conventional fluid regulating devices is that the compression gland element 220 applies a unidirectional force to the packing assembly 200, and the compression forces generated by the gland element 220 are unevenly distributed among and across the axially stacked packing elements 212. Further, the process fluid within the stationary equipment 202 also applies a compressive force to the packing assembly 210 in a direction opposite to the compression gland 220. The force applied by the process fluid is also unevenly distributed among and across the packing elements 212. Specifically, the axially outboard most packing element 212A that contacts the compression gland element 220 is exposed to higher compressive forces from the gland element than the axially innermost or inboard packing element 212B, which is located opposite to the packing element 212A. Similarly, the axially inboard most packing element 212B experiences higher compression forces from the process fluid than the outboard packing element 212A since the packing element 212B is disposed adjacent to the process fluid. Thus, the top or outboard packing element 212A is subjected to the highest compression gland load with minimal exposure to the process fluid pressure, while the bottom inboard packing element 212B is subjected to the least amount of gland load with the highest exposure to the process fluid pressure. As shown in FIG. 8, the compression force A applied by the compression gland element 220 acts upon the packing elements 212 of the packing assembly 210, with the packing element 212A experiencing the highest compression force from the gland element, and the compression force B applied by the process fluid also acts upon the packing elements 212, with the packing element 212B experiencing the highest compressive force from the process fluid pressure. As such, in conventional embodiments, about 70% of the total shaft sealing force or load is applied by the first two packing elements 212 on the outboard side, as indicated by the curve C in the graph 230. The radial pressure applied to the packing elements is indicated by D in the graph 230. As shown, an uneven distribution of load versus pressure is thus generated across the packing elements 212, with an increase in the density of the packing element 212A compared to the remaining packing elements in the packing assembly 210 when subjected to the gland compressive force, thus causing premature wear and localized frictional heat generation in the impacted packing elements.

### SUMMARY OF THE INVENTION

The present invention relates to a mechanical packing sealing system or assembly having an independent self-regulating pressure adjustment component to control the compression applied to a packing assembly based on process pressure variations. A reverse loading insert or element features a pressure balanced diameter that allows for a sufficient compression load on the packing assembly that adjusts automatically to the radial stress distribution along the packing assembly, and controls the lubrication needed for proper operation. This eliminates the need for periodic manual adjustment of the forces applied to the packing assembly by the gland via a gland element, as required in conventional fluid regulating devices. More specifically, the present invention is directed to a mechanical packing sealing assembly suitable for use with a fluid regulating device for reducing or minimizing fluid leakage therefrom. The mechanical packing sealing assembly provides sealing forces in both axial directions and can be self-regulating.

The present inventio is directed to a mechanical packing sealing assembly suitable for use with a fluid regulating device. The fluid regulating device can include a gland element for applying an axial pressure to a packing assembly in a first direction and a stationary equipment having a recess formed along an inner surface to form a stuffing box. The mechanical packing sealing assembly can include an axially movable pressure adjustment element having a main body that is sized and configured for seating within the recess formed in the stationary equipment. The main body can include a radially outwardly extending first flange element formed at a first end of the main body that is sized and configured for engaging with a radial surface of the stationary equipment and a radially inwardly extending second flange element formed at an opposed second end of the main body and forming a piston area that is sized and configured for being exposed to a pressure of a process fluid in the stationary equipment. The second flange element can be configured to selectively apply an axial force to the packing assembly when coupled to the main body, and the pressure adjustment element is movable axially as a function of the pressure of the process fluid applied to the piston area.

The second flange element is configured to selectively apply an axial force to the packing assembly in a second direction opposite to the first direction of the axial force applied by the gland element. This forms a bi-directional axial pressure assembly. Further, the pressure adjustment element is configured to move axially within the recess based on the pressure of the process fluid applied to the piston area to form a pressure self-regulating mechanism that regulates the axial pressure applied to the packing assembly during use.

The main body of the pressure adjustment element has an inner surface and an opposed outer surface, and the inner surface has a first groove formed therein at the first end of the main body corresponding to a location of the first flange element that is sized and configured for seating a first sealing element. The outer surface of the main body has a second groove formed therein at the second end of the main body corresponding to a location of the second flange element that is sized and configured for seating a second sealing element. The second groove formed in the second end can be formed in an outer surface of the second flange element. Further, an outer peripheral surface of the first flange element has a plurality of surface features formed therein. The surface features can include indents. The assembly can also employ an optional spacer element that is sized and configured for seating adjacent to the second flange element. The piston area of the second flange element is sized and configured for optionally converting 100% or more of the pressure of the process fluid into the axial force applied to the packing assembly.

The present invention is also directed to a method for regulating an axial pressure that is applied to a packing assembly in a fluid regulating device. The fluid regulating device can include a gland element and a stationary equipment having a recess formed along an inner surface forming a stuffing box. The method can include providing a pressure adjustment element suitable for mounting in the recess of the stationary equipment and sized for mounting a packing assembly, configuring the pressure adjustment element to be movable axially in response to a pressure of a process fluid in the stationary equipment applied to a piston area of the pressure adjustment element independent of the gland element, and configuring the piston area of the pressure adjustment element to apply an axial force to the packing assembly mounted in the stationary equipment and coupled to the pressure adjustment element during use based on the pressure of the process fluid.

The gland element during use can be configured to apply an axial force in a first direction to the packing assembly, and the method can include applying an axial force to the packing assembly with the pressure adjustment element during use in a second direction opposite to the first direction. The pressure adjustment element during use thus forms a pressure self-regulating mechanism that regulates the axial force applied to the packing assembly.

The pressure adjustment element can include a radially inwardly extending flange element formed at an axially inboard end thereof and the flange element forms the piston area. The method can include configuring the piston area to apply the pressure of the process fluid to the packing assembly during use. The method can also further include configuring the piston area to apply 100% or more of the pressure of the process fluid to the packing assembly, and converting with the piston area the process fluid pressure into an axial force.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic depiction of a fluid regulating device employing a mechanical packing sealing assembly according to the teachings of the present invention.

FIG. 2 is a partial cross-section view of the fluid regulating device of FIG. 1 showing some of the details of the mechanical packing sealing assembly according to the teachings of the present invention.

FIG. 3 is a partial cross-section view of the fluid regulating device of FIG. 1 showing the axial forces applied to the packing assembly when in use according to the teachings of the present invention.

FIG. 4 is a cross-sectional perspective view of the pressure adjustment element of the mechanical packing sealing assembly according to the teachings of the present invention.

FIG. 5 is a perspective view of the pressure adjustment element of the mechanical packing sealing assembly according to the teachings of the present invention.

FIG. 6 is a partial cross-sectional view of a conventional fluid regulating device showing the seating of a packing assembly in a stuffing box of stationary equipment.

FIG. 7 is a partial cross-sectional view of the conventional fluid regulating device of FIG. 6 showing the pressures applied to the packing assembly in the stuffing box by a gland element and a process fluid of the stuffing box.

FIG. 8 is a partial cross-sectional view of the conventional fluid regulating device of FIG. 6 showing the pressure profile of the forces applied to the packing assembly in the stuffing box by the gland element.

### DETAILED DESCRIPTION OF THE INVENTION

The present invention is directed to a mechanical packing sealing assembly suitable for use with a fluid regulating device for reducing or minimizing fluid leakage therefrom. The mechanical packing sealing assembly provides sealing forces in both axial directions and can be self-regulating.

As used herein, the term “fluid regulating device” is intended to encompass any selected device that helps, assists, prevents, pumps, or regulates the flow of a fluid through a fluid transport or conveyance medium, such as a pipe or device. The fluid regulating device is preferably of a type that employs a packing material, and can include valves, regulators, pumps, and the like. When a valve is employed, the valves can have any selected size and shape, and can include for example a hydraulic valve, a manual valve, a pneumatic valve, a solenoid valve, a motor valve, a block valve, and the like. Those of ordinary skill in the art will readily recognize that the packing material of the present invention can also be used with mechanical seals in connection with pumps.

The term “shaft” is intended to refer to any suitable device in a mechanical system to which a mechanical seal can be mounted and includes shafts, rods, and other known devices. The shafts can move in any selected direction, such as for example in a rotary direction or in a reciprocating direction.

The terms “axial” and “axially” as used herein refer to a direction generally parallel to the axis of a shaft. The terms “radial” and “radially” as used herein refer to a direction generally perpendicular or transverse to the axis of a shaft. The terms “fluid” and “fluids” refer to liquids, gases, and/or combinations thereof.

The terms “axially inner” or “axially inboard” as used herein refer to the portion of the stationary equipment proximate the stationary equipment and the process fluid. With regard to equipment that mounts packing elements, the direction refers to the packing elements located proximate the process fluid. Conversely, the terms “axially outer” or “axially outboard” as used herein refer to the portion of stationary equipment distal from the process fluid and proximate an ambient environment.

The term “radially inner” as used herein refers to the portion of the system proximate a shaft. Conversely, the term “radially outer” as used herein refers to the portion of the system distal from the shaft.

The term “gland” or “gland element” as used herein is intended to include any suitable structure that enables, facilitates, or assists securing a mechanical seal to stationary equipment, while concomitantly surrounding or housing, at least partially, one or more seal components. The gland element can also be configured to move axially to apply a compressive force to a packing assembly. If desired, the gland element can also provide fluid access to the mechanical seal. Those of ordinary skill will also recognize that the gland assembly can form part of the mechanical seal assembly or form part of the stationary equipment.

The terms “stationary equipment,” “equipment,” and/or “static surface” as used herein are intended to include any suitable stationary structure or housing that surrounds or houses a shaft or rod and includes a stuffing box within which a packing assembly is mounted or to which a gland element is secured. The stationary structure can include any type of commercial or industrial equipment such as pumps, valves, and the like. Those of ordinary skill in the relevant art will readily recognize that the gland assembly can form part of the mechanical seal, packing loading assembly or part of the stationary equipment.

The terms “process medium” and/or “process fluid” as used herein generally refers to a medium or fluid housed within or being transferred through the stationary equipment. In pump applications, for example, the process medium is the fluid being pumped through the pump housing.

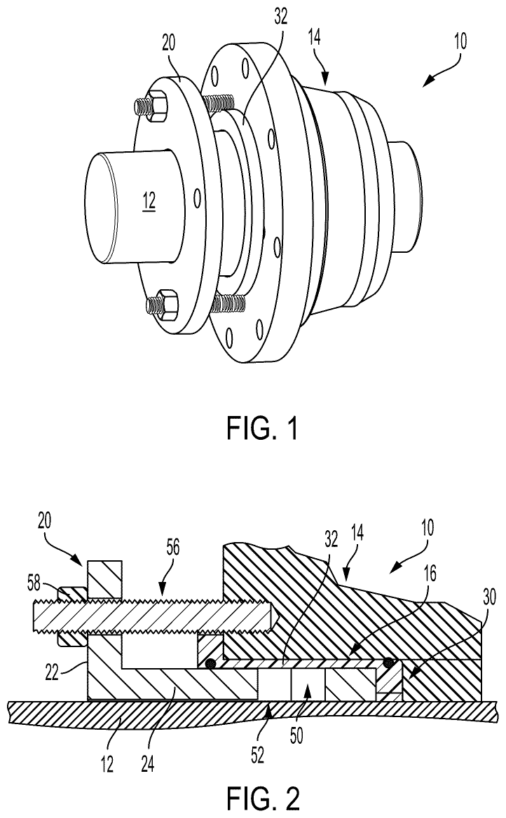

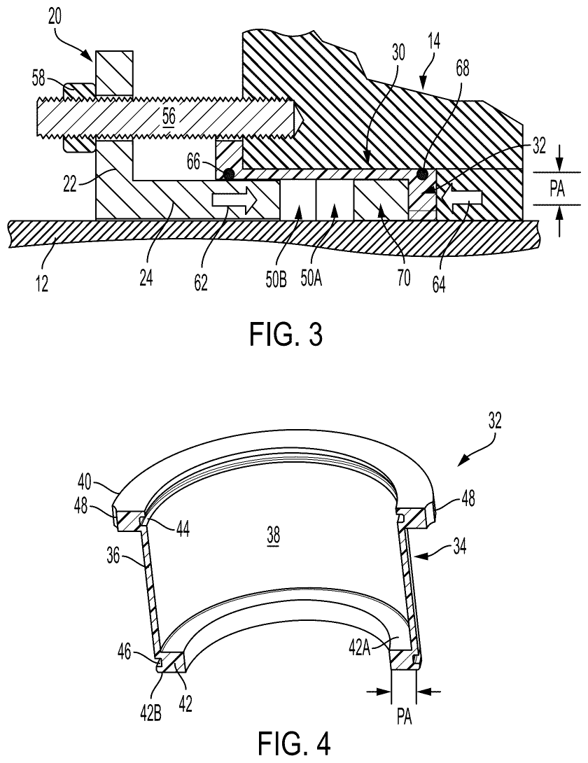

FIGS. 1-3 illustrate a fluid regulating device that includes a mechanical packing sealing assembly according to the teachings of the present invention. The illustrated fluid regulating device 10 includes a stationary equipment 14 that seats about a movable shaft 12, such as a rotating shaft. The fluid regulating device 10 also includes a compression gland or gland element 20. The stationary equipment 14 can include a groove 16 that is formed along an inner surface of the main body of the equipment to form the stuffing box. The groove 16 is sized and configured for seating a mechanical packing sealing assembly 30. The mechanical packing sealing assembly 30 is configured to seat and mount a series of packing elements 50. The packing elements 50, when mounted together in the mechanical packing sealing system 30, form a packing assembly 52.

The illustrated gland element 20 has a main body that has a top radially outwardly extending flange element 22 and an attached axially extending stem portion 24 that is oriented and positioned so as to contact a portion of the axial outboard most packing element (e.g., axial outboard packing element 50B) of the packing assembly 52. The gland element 20 can apply a compressive force to the packing assembly 52 by compressing the packing elements 50 in the axial direction so as to ensure sufficient sealing contact between the packing assembly 52 and the shaft 12. The axial compressive force squeezes the packing elements 50 so that they expand radially. The compressive forces applied by the gland element 20 can be manually adjusted by way of an adjustment mechanism. Specifically, the fluid regulating device 10 can include a series of fasteners 56 that connect and fasten the gland element 20 to the stationary equipment 14. The fluid regulating device 10 can also include a securing element 58, such as a nut, that functions as the adjustment mechanism for the fluid regulating device for adjusting or varying the compressive forces applied by the gland element 20 to the packing assembly 52. Specifically, the nut 58 can be adjusted by the user based on the amount of sealing force that needs to be applied to the packing assembly 52. For example, if the compressive forces applied to the packing assembly 52 need to be increased, the nut 58 can be adjusted such that the stem portion 24 of the gland element 20 moves axially inward to apply an enhanced or increased compressive force to the packing assembly 52. The gland element 20 applies a compressive force in a single axial inboard direction.

The packing assembly 52 can include a series of individually stacked, axially abutting packing elements 50 that are generally ring shaped and formed of a selected type of packing material. The packing material typically comes in rope form that is cut to size by the user. The packing material is then shaped as a ring. The packing assembly 52 is formed by initially stacking together separate packing elements 50. The seams of each of the packing elements 50 are oriented relative to each other and in a selected manner so as to reduce or minimize fluid leakage therethrough. The packing elements 50 are wrapped around the shaft 12 and provide an interface and dynamic sealing surface between the shaft 12 and the packing assembly 52. Over time, the packing assembly 52 tends to wear and lose volume, thus allowing emissions and process fluid to escape the fluid regulating device 10. In order to address the unwanted loss of volume and hence the increase in fluid loss and fugitive emissions, the operator or user can compress the packing assembly 52 further via the gland element 20.

The packing elements 50 of the packing assembly 52 of the present invention can have any selected shape and size, and can be formed in an interbraid pattern or a square braid pattern, or any other suitable braiding pattern known to those of ordinary skill in the art. The packing element 50 can be in the form of a braided packing material that is commonly square or round when viewed in cross section, although the packing element 50 can be provided in a variety of cross-sectional shapes. Multiple packing elements 50 can be provided in the recess 16 of the stationary equipment 14 along the length of the shaft 12 in order to provide a seal around the shaft 12. Although the present invention can be employed with any suitable type and shape of packing material, for the sake of simplicity, a square braid pattern can be employed and is shown. The square braid can be formed by braiding together multiple individual yarn components, typically of the same type of material, along a set of material paths. Further, the packing element 50 can be formed of a packing material that includes one or more yarn components that are disposed within a reinforcing material or structure, such as a wire mesh, to form a packing strand. The illustrated packing element 50 has a main body that has a plurality of side surfaces if a square braid. The main body can be optionally coated with any suitable material, such as polytetrafluoroethylene (PTFE), as is known in art. The yarn component can be formed of any suitable material and can be formed for example of graphite. Other materials include mica, vermiculite, and polytetrafluoroethylene (PTFE). The wire mesh can be formed of any suitable material, such as metal, examples of which include copper, brass, lead, Inconel, stainless steel, or monel materials. The illustrated packing element 50 is formed by braiding together individual packing strands or yarns to form the packing element. One of ordinary skill in the art will readily recognize that the packing material can be formed from multiple different types of materials and can be braided in a symmetrical or asymmetrical manner relative to a lateral or horizontal axis across a cross-sectional face of the packing material. The packing material forming the packing element can be selected for specific applications and to exhibit selected properties. Examples of various types of braids and braiding patterns are shown in U.S. Pat. No. 9,388,903, the contents of which are herein incorporated by reference. Examples of the type of packing elements suitable for use in the packing cartridge of the present invention include the 1400R, 1600, 1601, and 1622 brand packing materials sold by A.W. Chesterton Co., the assignee hereof. Other types of packing materials can also be used.

With reference to FIGS. 2-5, the illustrated mechanical packing sealing assembly 30 includes a pressure adjustment element 32 that seats within the recess or channel 16 formed in the inner surface of the stationary equipment 14 and operates, in part, as a sleeve component for seating the packing assembly 52. The pressure adjustment element 32 is configured to seat the packing elements 50 forming the packing assembly 52. The pressure adjustment element 32 is configured to exert an axial compressive force on the axial inboard side of the packing assembly, as shown by arrow 64, in a direction opposite to the force applied by the gland element 20, as shown by arrow 62. The pressure adjustment element 32 can help control the compressive forces applied to the packing assembly 52 based on variations in the pressure of the process fluid, thus operating as an independent pressure self-regulating mechanism. The pressure adjustment element 32 can have a pressure balance diameter that forms a selected compressive pressure load on the packing assembly 52 and helps adjust the radial stress distribution along the packing assembly, while concomitantly controlling the lubrication needed for proper operation of the fluid regulating device 10. The pressure adjustment element 32 eliminates the need for periodic manual adjustments of the gland element 20 by the operator.

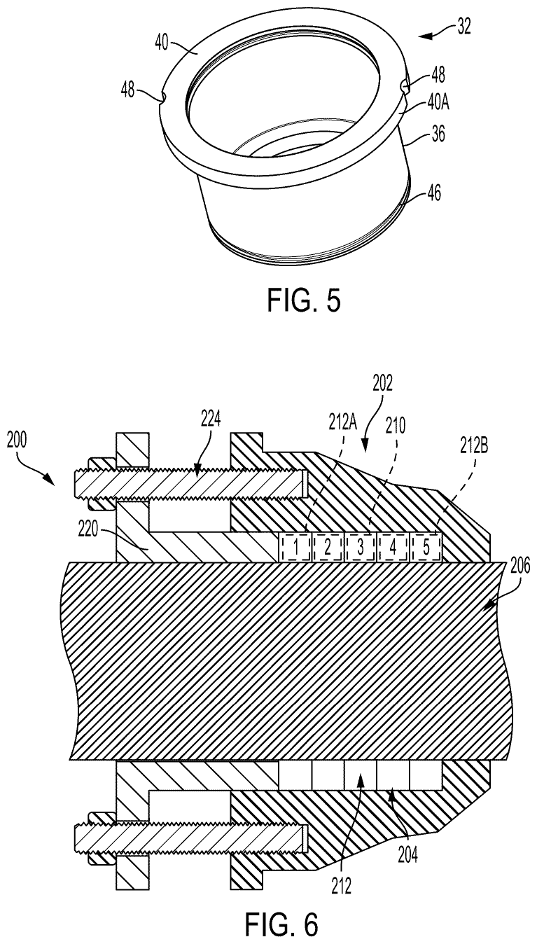

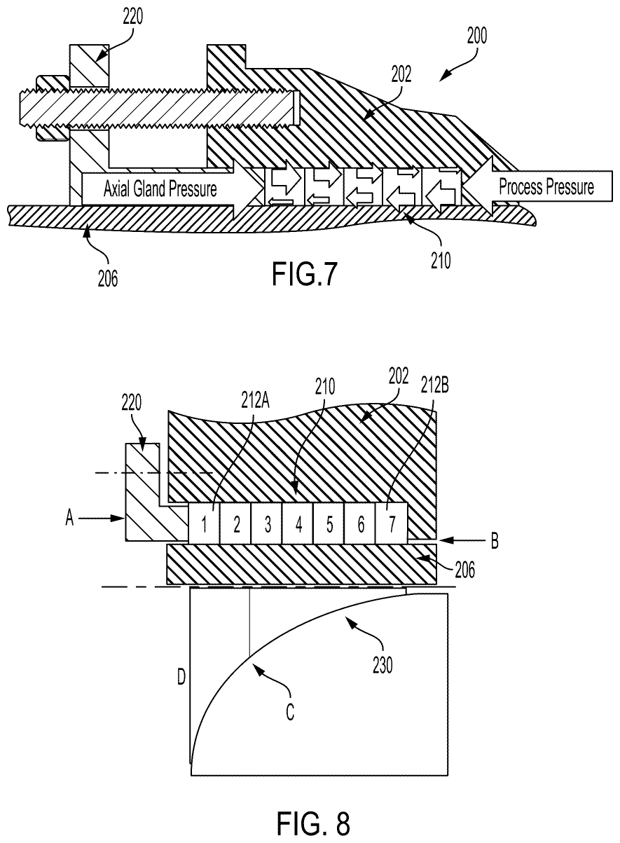

As shown in FIGS. 4 and 5, the illustrated pressure adjustment element 32 includes a main body 34 having an outer surface 36 and an opposed inner surface 38. The top portion of the main body has a flange element 40 formed thereon that extends radially outward from the outer surface 36. The flange element 40 can be configured to form the top terminal end of the pressure adjustment element 32. The flange element 40 is configured to engage with a top surface of the stationary equipment 14 when the pressure adjustment element 32 is seated within the recess or groove 16 (e.g., stuffing box). The inner surface 38 of the pressure adjustment element 32 has a radially inwardly extending flange element 42 that is located at a bottom portion of the main body 34. The flange element 42 can be configured to form the bottom terminal end of the pressure adjustment element 32. The bottom flange element 42 has a radially inwardly extending top surface 42A that is configured to contact the axial inboard-most packing element 50A and has an opposed bottom surface 42B. The bottom surface 42B is configured to contact or seat adjacent to the floor of the stuffing box. The overall radial width of the bottom flange element 42 forms a piston area PA that the process fluid within the stationary equipment 14 can act upon by applying a force thereto. The radial width of the bottom flange element 42 can be selectively sized. The piston area can be defined by the inside diameter of the floor or wall surface of the recess 16 and the diameter of the shaft 12. The inside diameter of the bottom flange element 42 is typically disposed adjacent to (e.g., very close to) the shaft 12. The surface area can be used from what is present in the equipment but can be changed. The shaft sealing surface can be changed with the common use of shaft sleeves, and the recess 16 can be increased by machining to preferred dimensions. The inner surface 38 of the main body 34, in the top flange element 40 portion, has a channel or groove 44 formed therein that is sized and configured for seating a scaling element, such as an O-ring 66. The sealing element 66 contacts an outer surface of the stem portion 24 of the gland element 20, so as to help reduce or prevent leakage of process fluid from the stationary equipment 14 along the stem portion 24. The outer surface 36 of the main body 34, in the region of the bottom flange element 42, has a channel or groove 46 formed along a bottom portion of the main body that is sized and configured for seating another scaling element, such as an O-ring 68. The sealing element 68 contacts an inner surface of the recess 16, so as to help prevent leakage of the process fluid from the stationary equipment 14 along the stuffing box.

The illustrated top flange element 40 also includes along a peripheral or circumferential outer surface 40A thereof one or more surface features, such as indents 48. The indents 48 align with and are configured to seat a portion of the outer surface of the fasteners 56. The indents 48 help prevent the pressure adjustment element 32 from rotating relative to the stationary equipment 14.

In operation, the pressure adjustment element 32 is mounted within the recess 16 (e.g., stuffing box) formed in the inner surface of the stationary equipment 14. The packing elements 50 are then mounted and stacked along the inner surface 38 of the main body 34 of the pressure adjustment element 32 to form the packing assembly 52. The axially innermost or axially inboard packing element 50A of the packing assembly 52 contacts the top surface 42A of the bottom flange element 42 of the pressure adjustment element 32. Alternatively, a spacer element 70 can be employed and can be mounted in place of the axially inboard packing element 50A, with the next adjacent packing element forming the packing element 50A. Those of ordinary skill in the art will readily recognize that the illustrated spacer element 70 can also represent a packing element and thus form the axially inboard or innermost packing element 50A. The remaining packing elements 50 are stacked along the inner surface 38 of the pressure adjustment element 32, with the packing element 50B forming the axially outboard or axially outermost packing element. The packing element 50B contacts the stem portion 24 of the gland element 20. The pressure adjustment element 32 is movable axially as a function of the pressure of the process fluid, arrow 64, when the process fluid applies a force on the piston area PA of the bottom flange element 42. The gland element 20 is then secured to the stationary equipment 14 by the fasteners 56, and the adjustment element 58 applies a force to the flange element 22 and forces the stem portion 24 of the gland element into mating and force generating contact with the axially outboard packing element 50B of the packing assembly 52. The stem portion 24 of the gland element 20 applies a compressive force to the packing elements 50 of the packing assembly 52. The packing elements 50 and the pressure adjustment element 32 can optionally form part of the mechanical packing sealing assembly 30 of the present invention.

As the pressure of the process fluid acts upon the piston area PA formed by the bottom flange element 42 of the pressure adjustment element 32, the pressure adjustment element 32 moves axially based on the force applied by the process pressure and applies a compressive force to the packing elements 50 in a direction opposite to the direction of the force applied by the gland element 20. The bi-directional compressive forces applied to the packing assembly 52 by the gland element 20 in one direction and the process fluid in the opposite direction, and the axially movable nature of the pressure adjustment element 32, forms a pressure self-regulating mechanism or subsystem that regulates the loading pressure or axial force applied to the packing elements 50 during use. For example, as the process fluid pressure increases, the pressure applied by the process fluid pressure to the piston area PA of the bottom flange element 42 also increases, thus axially moving the pressure adjustment element 32 in an axial outboard direction indicated by arrow 64. The axial movement applies a further compressive pressure to the packing assembly 52, thus increasing the overall compressive force applied to the packing elements 50. This occurs since the packing elements 50 are squeezed between the gland element 20 and the bottom flange element 42 of the pressure adjustment element 32. Further, the bottom flange element 42 can be configured to form the piston area PA of a selected size, so as to provide a force area that when exposed to the process fluid pressure provides a balanced load on the packing assembly 52. For example, the bottom flange element 42 can be sized so as to apply just a portion (e.g., less than all) of the total process fluid pressure to the packing assembly 52. Further, the piston area PA formed by the bottom flange element 42 can be preselected or adjusted by selecting the inside diameter of the flange element 42. By adjusting the size of the piston area PA formed by the bottom flange element 42, the amount of force applied by the process fluid to the pressure adjustment element 32 can be preselected or predetermined. In mechanical packing sealing systems, a small amount of process fluid leakage is expected and required for lubrication and cooling of the packing assembly 52, so as to maintain friction between the packing elements 50 and the rotating shaft 12. According to one embodiment, the pressure adjustment element 32 of the mechanical packing sealing assembly 30 can include a bottom flange element 42 having a piston area that translates between about 70% and about 80%, and optionally as much as 100%, and further optionally higher than 100%, such as for example between about 100% and about 120% (e.g., 110%), of the process fluid pressure into an axial compressive force, as indicated by arrow 64. As such, the flange element 42 can be configured to translate a selected percentage of the process fluid pressure to an axial compressive force. Further, the piston area PA acting on the packing assembly 52 can reach generally the shaft diameter, as the area of the packing assembly 52 between the shaft 12 and an inside diameter of the bottom flange element 42 is also exposed to process fluid pressure. The percentage of the process fluid pressure that can be converted into an axial pressure by the piston area PA can be determined by dividing the piston area by the area of the stuffing box. By way of simple example, if the shaft has a diameter of 2 inches, the packing assembly 52 has a diameter of about 3 inches, and the diameter as defined by the groove 16 (e.g., stuffing box) is about 3.125 inches, and the bottom flange element 42 has an inner diameter of 2.25 inches. The balance percentage or the amount of process fluid pressure used for loading the packing assembly 52 is equivalent to the area of the piston area divided by the area of the cross-section of the stationary equipment:

$$π / 4 ( 3.1 \; 25 - 2 ) / π / 4 ( 3. - 2. ) = 1.125 = 112 \% .$$

Therefore, the system 10 is balanced so that a portion of the full process fluid pressure acts upon the bottom flange element 42 to provide a force or load on the packing assembly 52.

The self-regulating nature of the mechanical packing sealing assembly 30 eliminates or is free of the need to manually adjust the compression on the packing assembly 52 with the gland element 20, since the pressure adjustment element 32 moves axially based on the pressure or forces applied by the process fluid. The axial movement of the pressure adjustment element is thus independent of the gland element. As such, there is no need to manually adjust the pressure applied by the gland element 20. The balanced pressure nature of the axial forces or load on the packing assembly 52 better distributes the forces across all of the packing elements 50 in the packing assembly 52 in an axial and radial manner, rather than just localizing the compressive forces selected ones of the packing elements 50A, 50B, thus reducing the overall wear of the packing elements. Further, the mechanical packing sealing system 30 can be employed in different stuffing box styles (e.g., straight bore or bottomed bore). The piston area of the pressure adjustment element provides for a pressure balanced self-regulating mechanical packing sealing assembly.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

We claim:

1. A mechanical packing sealing assembly suitable for use with a fluid regulating device having a gland element and a stationary equipment having a recess formed along an inner surface, comprising an axially movable pressure adjustment element having a main body that is sized and configured for seating within the recess formed in the stationary equipment, wherein the main body has a radially outwardly extending first flange element formed at a first end of the main body that is sized and configured for engaging with a radial surface of the stationary equipment and a radially inwardly extending second flange element formed at an opposed second end of the main body and forming a piston area that is sized and configured for being exposed to a pressure of a process fluid in the stationary equipment, wherein the second flange element is configured to selectively apply an axial force to a packing assembly when coupled to the main body, and wherein the pressure adjustment element is movable axially as a function of the pressure of the process fluid applied to the piston area.

2. The mechanical packing sealing assembly of claim 1, wherein the gland element is configured to apply an axial pressure to the packing assembly in first direction during use, and wherein the second flange element is configured to selectively apply an axial force to the packing assembly in a second direction opposite to the first direction.

3. The mechanical packing sealing assembly of claim 2, wherein the pressure adjustment element is configured to move axially within the recess based on the pressure of the process fluid applied to the piston area to form a pressure self-regulating mechanism that regulates the axial pressure applied to the packing assembly during use.

4. The mechanical packing sealing assembly of claim 3, wherein the main body of the pressure adjustment element has an inner surface and an opposed outer surface, and wherein the inner surface has a first groove formed therein at the first end of the main body corresponding to a location of the first flange element that is sized and configured for seating a first sealing element.

5. The mechanical packing sealing assembly of claim 4, wherein the outer surface of the main body has a second groove formed therein at the second end of the main body corresponding to a location of the second flange element that is sized and configured for seating a second sealing element.

6. The mechanical packing sealing assembly of claim 5, wherein the second groove formed in the second end is formed in an outer surface of the second flange element.

7. The mechanical packing sealing assembly of claim 6, wherein an outer peripheral surface of the first flange element has a plurality of surface features formed therein.

8. The mechanical packing sealing assembly of claim 7, wherein the surface features comprise indents.

9. The mechanical packing sealing assembly of claim 6, further comprising a spacer element sized and configured for seating adjacent to the second flange element.

10. The mechanical packing sealing assembly of claim 3, wherein the piston area of the second flange element is sized and configured for converting 100% or more of the pressure of the process fluid into the axial force applied to the packing assembly.

11. A method for regulating an axial pressure applied to a packing assembly in a fluid regulating device, wherein the fluid regulating device includes a gland element and a stationary equipment having a recess formed along an inner surface, comprising
providing a pressure adjustment element suitable for mounting in the recess of the stationary equipment and sized for mounting a packing assembly,
configuring the pressure adjustment element to be movable axially in response to a pressure of a process fluid in the stationary equipment applied to a piston area of the pressure adjustment element independent of the gland element, and
configuring the piston area of the pressure adjustment element to apply an axial force to the packing assembly mounted in the stationary equipment and coupled to the pressure adjustment element during use based on the pressure of the process fluid.

12. The method of claim 11, wherein the gland element during use applies an axial force in a first direction to the packing assembly, further comprising applying an axial force to the packing assembly with the pressure adjustment element during use in a second direction opposite to the first direction.

13. The method of claim 12, wherein the pressure adjustment element during use forms a pressure self-regulating mechanism that regulates the axial force applied to the packing assembly.

14. The method of claim 13, wherein the pressure adjustment element includes a radially inwardly extending flange element formed at an axially inboard end thereof, wherein the flange element forms the piston area, further comprising configuring the piston area to apply the pressure of the process fluid to the packing assembly during use.

15. The method of claim 14, further comprising configuring the piston area to apply 100% or more of the pressure of the process fluid to the packing assembly.

16. The method of claim 14, further comprising converting with the piston area the process fluid pressure into an axial force.
